(19) United States
(12) Patent Application Publication
(10) Pub. No.: US 2021/0311469 A1
(43) Pub. Date: Oct. 7, 2021

(54) INTELLIGENT VEHICLE MOTION CONTROL METHOD AND APPARATUS, DEVICE AND STORAGE MEDIUM

(71) Applicant: SHANGHAI SENSETIME INTELLIGENT TECHNOLOGY CO., LTD., Shanghi (CN)

(72) Inventor: Junwei ZHANG, Shanghai (CN)

(21) Appl. No.: 17/351,445

(22) Filed: Jun. 18, 2021

Related U.S. Application Data
(63) Continuation of application No. PCT/CN2020/092161, filed on May 25, 2020.

(30) Foreign Application Priority Data
Jun. 19, 2019 (CN) 201910533908.1

(51) Int. Cl. G05D 1/00; G06K 9/00; G06K 9/62; H04N 5/232; G06T 7/50

(52) U.S. Cl. CPC G05D 1/0016; G06K 9/00355; G06T 7/50; G06K 9/6267; H04N 5/232125; G06K 9/6298

(57) ABSTRACT

An intelligent vehicle motion control method and apparatus, and storage medium are provided. The method includes that: an image to be processed is acquired; gesture recognition is performed on the image to be processed to obtain pose information of a gesture in the image to be processed; and a motion state of an intelligent vehicle is controlled according to the pose information.

### CROSS-REFERENCE TO RELATED APPLICATIONS

This application is a continuation of International Patent Application No. PCT/CN2020/092161, filed on May 25, 2020, which claims priority to Chinese Patent Application No. 201910533908.1, filed on Jun. 19, 2019. The contents of International Patent Application No. PCT/CN2020/092161 and Chinese Patent Application No. 201910533908.1 are incorporated herein by reference in their entireties.

### BACKGROUND

In related art, the operation of a wireless remote control vehicle is controlled by different gestures, mostly based on an armband or a wristband, touch screen sensing, and gesture images. For example, a gesture operation of a user on a touch screen is acquired and then gesture coordinates are determined by the related gesture operation to determine a type of gesture, so that the related control is realized.

### SUMMARY

The present disclosure relates to the technical field of automatic driving of an apparatus, and particularly to, but is not limited to, a method and an apparatus for controlling intelligent device motion, a device and a storage medium.

An embodiment of the present disclosure provides a method for controlling intelligent device motion, which includes the following operations. An image to be processed is acquired. Gesture recognition is performed on the image to be processed to obtain pose information of a gesture in the image to be processed. A motion state of the intelligent vehicle is controlled according to the pose information.

An embodiment of the present disclosure provides an apparatus for controlling intelligent device motion, which includes: a processor, and a memory configured to store instructions executable by the processor, where the processor is configured to: acquire an image to be processed; perform gesture recognition on the image to be processed to obtain pose information of a gesture in the image to be processed; and control a motion state of an intelligent vehicle according to the pose information.

An embodiment of the present disclosure provides an apparatus for controlling intelligent device motion, which includes: a first acquisition module, configured to acquire an image to be processed; a first recognition module, configured to perform gesture recognition on the image to be processed to obtain pose information of a gesture in the image to be processed; and a first control module, configured to control a motion state of an intelligent vehicle according to the pose information.

An embodiment of the present disclosure provides a computer storage medium, having stored thereon computer executable instructions that, when being executed, enable to implement the steps in the method for controlling intelligent device motion provided in the embodiments of the present disclosure.

An embodiment of the present disclosure provides a computer device including a memory and a processor. The memory is configured to store computer-executable instructions, and the processor is configured to, upon execution of the computer executable instructions on the memory, implement the steps in the method for controlling intelligent device motion provided in the embodiments of the present disclosure.

An embodiment of the present disclosure further provides a computer program product including computer executable instructions that, when being executed, enable to implement the steps in the method for controlling intelligent device motion provided in the embodiments of the present disclosure.

Embodiments of the present disclosure provide a method and an apparatus for controlling intelligent device motion, a device and a storage medium. By performing gesture recognition on an image to be processed, gestures in the image can be effectively recognized, and thus a state of the intelligent vehicle can be accurately controlled by using the gestures. Therefore, the accuracy of recognizing the gesture in the image to be processed is improved, and the accuracy of controlling the state of the intelligent vehicle based on the gestures is also improved.

### BRIEF DESCRIPTION OF THE DRAWINGS

To more clearly illustrate some of the embodiments disclosed herein, the following is a brief description of drawings. The drawings in the following descriptions are only illustrative of some embodiments. For those of ordinary skill in the art, other drawings of other embodiments can become apparent based on these drawings.

FIG. 1 is a schematic flowchart of a method for controlling intelligent device motion according to an embodiment of the present disclosure.

FIG. 2A is another schematic flowchart of a method for controlling intelligent device motion according to an embodiment of the present disclosure.

FIG. 2B is yet another schematic flowchart of a method for controlling intelligent device motion according to an embodiment of the present disclosure.

FIG. 3 is a schematic flowchart of a method for controlling intelligent device motion according to an embodiment of the present disclosure.

FIG. 4 is a schematic flowchart of an image pre-processing procedure according to an embodiment of the present disclosure.

FIG. 5 is a schematic flowchart of identifying a pre-processed image according to an embodiment of the present disclosure.

FIG. 6 is a schematic diagram of a scenario of gesture categories according to an embodiment of the present disclosure.

FIG. 7 is a schematic structural diagram of encapsulation information according to an embodiment of the present disclosure.

FIG. 8A is a schematic flowchart of adjusting acquisition direction of an intelligent vehicle according to an embodiment of the present disclosure.

FIG. 8B is another schematic flowchart of adjusting acquisition direction of an intelligent vehicle according to an embodiment of the present disclosure.

FIG. 9 is a schematic structural diagram of an apparatus for controlling intelligent device motion according to an embodiment of the present disclosure.

FIG. 10 is a schematic diagram of a composition structure of a computer device according to an embodiment of the present disclosure.

### DETAILED DESCRIPTION

In order to make the purpose, technical solution, and advantages of the embodiments of the present disclosure more clear, specific technical solutions of the present disclosure will be described in further detail below in conjunction with the drawings of the embodiments of the present disclosure. The following embodiments serve to illustrate the present disclosure, and are not intended to limit the scope of the present disclosure.

Embodiments of the present disclosure first provide an application system for controlling motion of an intelligent vehicle, which includes an intelligent vehicle, a Raspberry Pi, a camera, and an intelligent education robot. The Raspberry Pi and the camera may be integrated on the intelligent vehicle, or may be independent of the intelligent vehicle and the intelligent education robot such as EV3. In the embodiments of the present disclosure, first, the Raspberry Pi performs gesture classification on a gesture in an image captured by the camera and determines an area where the gesture is located. Then, the Raspberry Pi sends the classification result to the intelligent education robot. The intelligent education robot obtains a control instruction according to the classification result of the gesture, and controls the motion of the intelligent vehicle according to the control instruction.

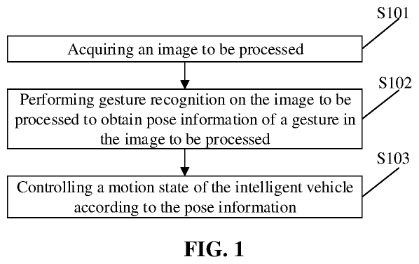

An embodiment of the present disclosure provides a method for controlling intelligent device motion. The method steps provided in the present disclosure may be executed by hardware, such as an intelligent vehicle, a computer, a mobile phone, a server, or implemented by a processor running computer-executable code. FIG. 1 is a schematic flowchart of a method for controlling intelligent device motion according to an embodiment of the present disclosure. Descriptions will be made below in connection with the method shown in FIG. 1.

In S101, an image to be processed is acquired.

In some embodiments, the operation S101 may be implemented by acquiring the to be processed image by an acquisition device (for example, a camera) connected to the intelligent vehicle, or implemented by installing a Raspberry Pi in the intelligent vehicle and acquiring the image by using the Raspberry Pi to control the acquisition device, or implemented by receiving the image to be processed transmitted by other devices. The image to be processed may or may not contain a gesture. The image to be processed may be one frame of image in the acquired video sequence.

In S102, gesture recognition is performed on the image to be processed to obtain pose information of a gesture in the image to be processed.

In some embodiments, the image to be processed is inputted to a neural network, and feature extraction is performed by the neural network to obtain an image feature. The pose information of the gesture includes position information of the gesture, a direction of the gesture, and a category to which the gesture belongs. First, a target candidate box is determined based on the image feature, where a probability that the target candidate box includes a gesture is greater than a probability threshold, a first coordinate of the candidate box is determined in the image to be processed, and the first coordinate is used as position information of the gesture. Then, the target candidate box is inputted into a classification network to determine whether a gesture is contained in the target candidate box. If the target candidate box contains a gesture, the category of the gesture belongs is determined.

In S103, a motion state of the intelligent vehicle is controlled according to the pose information.

In some embodiments, the intelligent vehicle may be an intelligent toy vehicle, vehicles with various functions, vehicles of various wheels, etc., or a robot, etc. An instruction corresponding to the pose information is sent to the intelligent vehicle to adjust the motion state of the intelligent vehicle. The motion state of the intelligent vehicle includes a stationary state, a steering state, a backward state, a forward state, and the like. The operations S103 may be implemented as follows. An instruction corresponding to the category of the gesture is sent to the controller of the intelligent vehicle to control the motion direction of the intelligent vehicle. Alternatively, the Raspberry Pi generates a control instruction according to the pose information to control the motion direction of the intelligent vehicle. The controller may be a controller inside the intelligent vehicle, or may be the third-generation Mindstorms robot of LEGO (abbreviated as EV3) that is independent of the intelligent vehicle and used to control the direction of motion of the intelligent vehicle.

In the embodiment of the present disclosure, the feature extraction is performed on the image to be processed based on the neural network to obtain the image feature is accurately, so that the category of the gesture is determined, and the control instruction is determined according to the category of the gesture, thereby effectively controlling the motion direction of the intelligent vehicle.

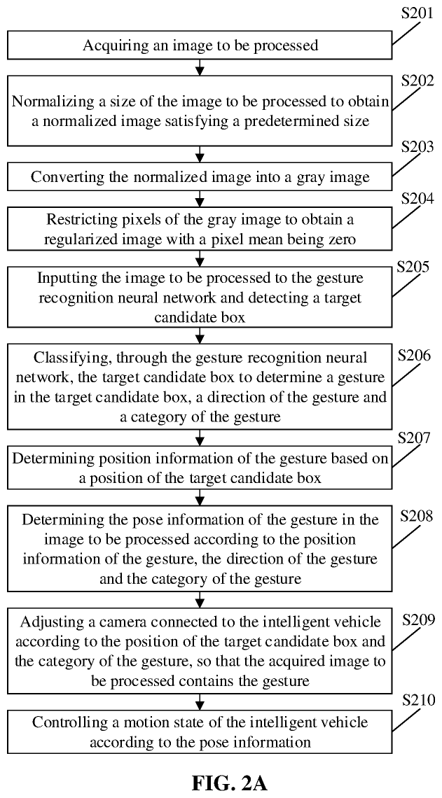

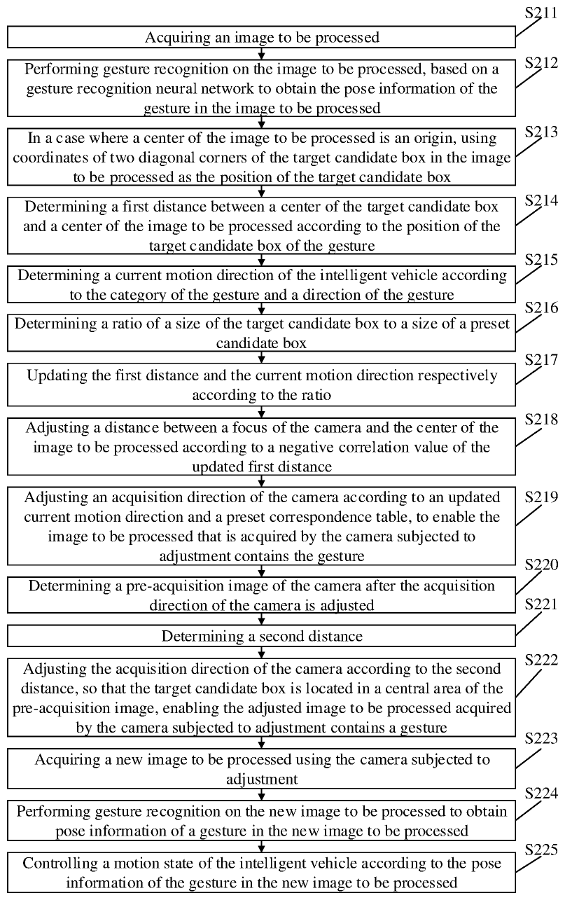

An embodiment of the present disclosure provides a method for controlling intelligent device motion. FIG. 2A is another schematic flowchart of a method for controlling intelligent device motion according to an embodiment of the present disclosure, and description will be made below in connection with the method in FIG. 2A.

In S201, an image to be processed is acquired.

In S202, a size of the image to be processed is normalized to obtain a normalized image satisfying a predetermined size.

In some embodiments, if the image to be processed is a multi-frame image in a video sequence, the video sequence needs to be decomposed into a plurality of images according to the frame rate of the video sequence. Then, the size of each of the plurality of images is normalized to make the sizes of the plurality of images consistent, and thus after the image to be processed is inputted to the neural network, consistent feature maps are output.

In S203, the normalized image is converted into a gray image.

In some embodiments, the color features of the normalized image are ignored, and the normalized image is converted to a gray image.

In S204, regularization processing is performed on pixels of the gray image to obtain a regularized image with a pixel mean being zero.

In some embodiments, the pixels of the gray image are decentralized. That is to say, the average value of the pixels at each position in the image is 0, so that the pixel value range becomes [−128, 127], centered at 0. Because when the positive and negative number of pixels at each position is “almost the same”, the direction of change of the gradient becomes uncertain, so that the convergence of the weights can be accelerated.

The operations S202 to S204 provide an implementation for pre-processing the image to be processed. In this implementation, the image to be processed is subjected to normalization processing, then color conversion is performed, and finally regularization processing is performed to obtain a regularized image whose pixel mean is 0, which facilitates subsequent feature extraction and classification of gestures.

In S205, the image to be processed is inputted to the gesture recognition neural network and a target candidate box is detected.

In some embodiments, the image to be processed is inputted to the neural network for feature extraction, and a target candidate box is determined based on the extracted image feature, where a probability that target candidate box contains a gesture is greater than a preset probability threshold.

In S206, the target candidate box is classified through the gesture recognition network to determine a gesture in the target candidate box, a direction of the gesture, and a category of the gesture.

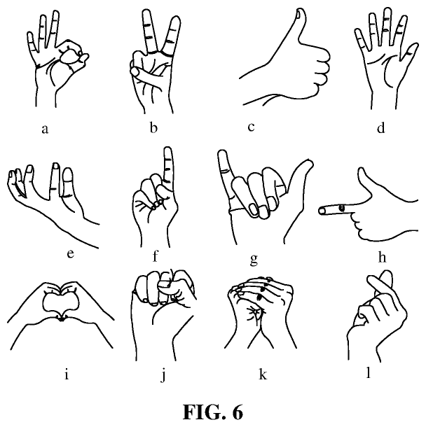

In some other implementations, determining the category and the direction of the gesture may also include: searching from a preset gesture category library a target gesture whose similarity to the image feature in the target candidate box is greater than a preset similarity threshold, and determining the category and the direction corresponding to the target gesture as the category and the direction of the gesture. As shown in FIG. 6 (c), the gesture direction is upward, and the gesture category is to raise the thumb.

In S207, position information of the gesture is determined based on a position of the target candidate box.

In some embodiments, the position information of the gesture is determined based on the target candidate box in response to the target candidate box including the gesture. For example, in a case where a center of the image to be processed is the origin, the coordinates of the two diagonal corners of the target candidate box in the image to be processed are used as the position of the target candidate box. In some specific examples, the coordinates of the upper left corner and the lower right corner of the target candidate box in the image to be processed may be determined as the coordinates of the target candidate box, to determine the position information of the gesture. In response to the image to be processed not including a gesture, the image to be recognized is identified by using a preset identification field, which reduces repeated identification of the image not including the gesture and reduces waste of resources.

In S208, the pose information of the gesture is determined in the image to be processed according to the position information of the gesture, the direction of the gesture and the category of the gesture.

The operations S205 and S208 provide an implementation of “determining pose information of a gesture”, where the pose information includes position information of the gesture, a category and a direction of the gesture, and the position information and the category of the gesture are determined by a neural network, so that the category to which the gesture belongs can be more accurately recognized, thereby effectively controlling motion of the intelligent vehicle.

In S209, a camera connected to the intelligent vehicle is adjusted according to the position of the target candidate box and the category of the gesture, so that the acquired image to be processed contains the gesture.

In some embodiments, adjusting the acquisition direction of the intelligent vehicle may include: adjusting a motion direction of a support member for the acquisition device in the intelligent vehicle to change the acquisition direction of the acquisition device, for example, adjusting the motion direction of a cradle head or platform supporting the acquisition device.

The operation S209 may be implemented as follows. First, a first distance between a center of the target candidate box and a center of the image to be processed is determined according to the position of the target candidate box of the gesture. Then, a distance between an image acquisition focus of the camera and the center of the image to be processed is adjusted according to a negative correlation value of the first distance, so that an image to be processed acquired by the camera subjected to adjustment contains a gesture. For example, the deviation from the focal length of the intelligent vehicle to the center of the image to be processed is adjusted according to the position of the target candidate box, so that the gesture in the image to be processed acquired by the intelligent vehicle is located in a center position. In this way, after the image acquisition focus of the intelligent vehicle is adjusted, a gesture is included in the image to be processed acquired by the intelligent vehicle. Then, a current motion direction of the intelligent vehicle is determined according to the category of the gesture and a direction of the gesture, where categories of the gesture and directions of the gesture have one-to-one correspondence with motion directions of the intelligent vehicle. An acquisition direction of the camera is adjusted according to the current motion direction and a preset correspondence table, where the preset correspondence table includes a correspondence between the current motion direction and the acquisition direction. In this way, even if the intelligent vehicle is moving in real time, it is still possible to make the image to be processed acquired by the camera contain a gesture, and the gesture is in a center position of the image to be processed.

In S210, a motion state of the intelligent vehicle is controlled according to the pose information.

In the embodiment of the present disclosure, the neural network is used for analyzing the image to be processed to accurately identify the category of the gesture, and the acquisition direction of the camera is adjusted in real time so that the gesture in the image to be processed acquired by the intelligent vehicle is in the center position, which significantly improves the detection effect and thus the motion state of the intelligent vehicle is effectively controlled.

An embodiment of the present disclosure provides a method for controlling intelligent device motion. FIG. 2B is yet another schematic flowchart of a method for controlling intelligent device motion according to an embodiment of the present disclosure, and description will be made below with reference to the method shown in FIG. 2B.

In S211, an image to be processed is acquired.

In S212, gesture recognition is performed on the image to be processed based on a gesture recognition neural network to obtain pose information of a gesture in the image to be processed.

In some embodiments, the pose information of the gesture includes a category of the gesture and a direction of the gesture.

In S213, in a case where a center of the image to be processed is an origin, coordinates of two diagonal corners of the target candidate box in the image to be processed are used as the position of the target candidate box.

In some embodiments, since the target candidate box contains a gesture, the position information of the gesture is determined after the position of the target candidate box is determined.

In S214, a first distance between a center of the target candidate box and the center of the image to be processed is determined according to the position of the target candidate box of the gesture.

In some embodiments, the coordinates of the center of the target candidate box may be determined based on the coordinates of the upper left corner and the lower right corner of the target candidate box, and a distance between the center of the target candidate box and the center of the image to be processed, namely the first distance, is determined based on the coordinates of the center of the target candidate box.

In S215, a current motion direction of the intelligent vehicle is determined according to a category of the gesture and a direction of the gesture. In some embodiments, categories of the gesture have one-to-one correspondence with motion directions of the intelligent vehicle. As shown in Table 2, for example, if a gesture is Victory and a direction of the gesture is upward, then the motion direction of the intelligent vehicle moves forward correspondingly.

In S216, a ratio of a size of the target candidate box to a size of a preset candidate box is determined.

In some embodiments, the size of the preset candidate box may be customized by the user. The edge of the target candidate box may be detected by the neural network to determine the size of the target candidate box, and then the ratio of the size of the target candidate box to the size of the preset candidate box is determined.

In S217, the first distance and the current motion direction are updated respectively according to the ratio.

In some embodiments, the S217 may be implemented as follows. First, a first weight value corresponding to the first distance and a second weight value corresponding to the current motion direction are determined according to the ratio. In some specific examples, a preset ratio interval corresponding to the ratio is determined, the first weight value corresponding to the first distance and the second weight value corresponding to the current motion direction are determined based on the preset ratio interval where the ratio is located and a mapping table (as shown in Table 1) indicating a correspondence between ratio intervals and weight values. Since whether the center of the target candidate box is located at the center of the image to be processed is determined by the first distance, the first weight value may be set to a fixed value, for example, set to 1. For the second weight value, when the ratio increases, the second weight is increased accordingly. As shown in Table 1, for example, if the ratio of the size of the target candidate box to the size of the preset candidate box is less than 0.8, the first weight value corresponding to the first distance is 1, and the second weight value corresponding to the current motion direction is 0.5. If the ratio of the size of the target candidate box to the size of the preset candidate box is greater than 0.8 and less than 1.2, the second weight value corresponding to the current motion direction is 0.6. Then, the first distance is updated according to the first weight value to obtain the updated first distance. For example, the updated first distance is obtained by multiplying the first weight value by the first distance. Finally, the current motion direction is updated according to the second weight value to obtain the updated current motion direction. For example, in the intelligent vehicle, the acquisition device is used to acquire the image to be processed, and the second weight value is used to control the magnitude of current motion speed of the intelligent vehicle to control the motion speed of the acquisition device of the intelligent vehicle, so as to adjust the acquisition direction of the acquisition device.

In S218, a distance between a focus of the camera and the center of the image to be processed is adjusted according to a negative correlation value of the first distance.

In some embodiments, the distance between the image acquisition focus of the intelligent vehicle and the center of the image to be processed is adjusted to negatively correlate with the updated first distance. The distance between the focus of the intelligent vehicle and the center of the image to be processed is adjusted in a non-linear negative correlation manner based on the updated first distance. If the updated first distance is large, it is represented that the center of the target candidate box deviates from the center of the image to be processed; that is to say, the focus of the intelligent vehicle deviates from the center of the image to be processed. In this case, the distance between the focus of the intelligent vehicle and the center of the image to be processed is adjusted to have a non-linear negative correlation with the first distance.

In S219, an acquisition direction of the camera is adjusted according to an updated current motion direction and a preset correspondence table, so that the image to be processed acquired by the camera subjected to adjustment contains a gesture.

In some embodiments, the preset correspondence table is used to indicate a correspondence between the current motion direction and the acquisition direction. That is to say, each motion direction corresponds to a respective acquisition direction of the camera. The operation S219 may be understood as follows. A target motion direction identical to the updated current motion direction is searched in the preset correspondence table, and the target motion direction may indicate an adjustment mode for the acquisition direction of the camera in the preset correspondence table. Then, the acquisition direction of the camera is adjusted by the adjustment mode. For example, when the current motion direction is the forward direction, the rise amount of the camera is reduced in the vertical direction. When the current motion direction is reverse direction, the rise amount of the camera is increased in the vertical direction. Therefore, the position of the acquisition device can be flexibly adjusted to better capture the image containing gestures.

The above operations S216 to S219 provide an implementation for “adjusting the camera connected to the intelligent vehicle according to the position of the target candidate box and the category and direction of the gesture”. In the implementation, the ratio of the preset candidate box to the target candidate box is determined to determine the weight values of two parameters (i.e., the first distance and the current motion direction of the intelligent vehicle) for adjusting the acquisition direction of the camera, and to update the two parameters, so that the acquisition direction of the acquisition device of the intelligent vehicle can be adjusted in real time.

In S220, a pre-acquired image of the camera is determined after the acquisition direction of the camera is adjusted.

In some embodiments, after the acquisition direction of the camera connected to the intelligent vehicle is adjusted, the gesture in the pre-acquired image may still not be at the center of the image. In this case, it is necessary to use the difference between the gesture in the pre-acquired image and the center of the image as a feedback result so as to continue adjusting the acquisition direction of the camera based on the feedback result. For example, before performing the S219, the first distance between the center of the target candidate box and the center of the image to be processed is 10 mm. After the operation S219 is executed, the difference between the gesture in the pre-acquired image and the center of the image to be processed is 3 mm. Then, the difference of 3 mm is used as the second feedback to inform the controller that the acquisition direction of the camera still needs to be adjusted.

In S221, a second distance is determined.

In some embodiments, the second distance is a distance between a center of a target candidate box in the pre-acquired image and a center of the pre-acquired image. The target candidate box contains a gesture.

In S222, the acquisition direction of the camera is adjusted according to the second distance, so that the target candidate box is located in a central area of the pre-acquired image, enabling an image to be processed acquired by the camera subjected to adjustment contains a gesture.

In S223, a new image to be processed is acquired using the camera subjected to adjustment.

In S224, gesture recognition is performed on the new image to be processed to obtain pose information of a gesture in the new image to be processed.

In S225, a motion state of the intelligent vehicle is controlled according to the pose information of the gesture in the new image to be processed.

In some embodiments, based on the difference between the center of the target candidate box of the gesture in the pre-acquired image from the second feedback and the center of the pre-acquired image, the acquisition direction of the camera continues to be adjusted to make the center of the target candidate box of the gesture is located in the center area of the pre-acquired image, so that the gesture in the acquired image to be processed is located in the center of the image, which facilitates improving the accuracy of gesture recognition.

In the embodiment of the present disclosure, after the acquisition direction of the camera is adjusted based on the position information, the category and the direction of the gesture, if the target candidate box of the gesture is still not in the center of the image to be processed, the difference between the gesture and the center of the image to be processed is taken as the second feedback, and the acquisition direction of the camera is further adjusted based on the second feedback so that the gesture is in the center of the image to be processed, thereby more accurately controlling the motion of the intelligent vehicle by the gesture.

In related art, a wireless remote control intelligent vehicle employs a wireless remote control device to realize operations such as steering, and with the emergence and vigorous development of deep learning technology, gesture recognition as a scheme for the wireless remote control vehicle becomes a new bright spot and a hot spot. However, gesture recognition scheme are mostly based on an armband or a wristband, touch screen sensing, and gesture image. For example, the gesture recognition scheme can be realized in the following modes.

Mode 1: motion and pose of the user's arm are detected through a motion sensor unit by an arm ring device worn on the user's arm, so that the remote control of a toy vehicle is realized.

Mode 2: a gesture operation of the user on the touch screen is acquired and the coordinates of the gesture is determined by the related operation, to determine a type of the gesture, and on this basis, the related control is realized.

Mode 3: gesture information is collected by a camera and intelligent human-computer interactive image information processing technology is used to control the vehicle and depict a map, which realizes automatic obstacle avoidance for the vehicle in the automatic motion mode.

Mode 4: gesture recognition is implemented by segmenting a target area of a gesture, then performing edge detection and contour extraction, and mapping to a new feature space. According to the gesture recognition schemes described above, although the basic gesture classification can be realized, these modes are much more dependent on hardware and the recognition accuracy needs to be improved.

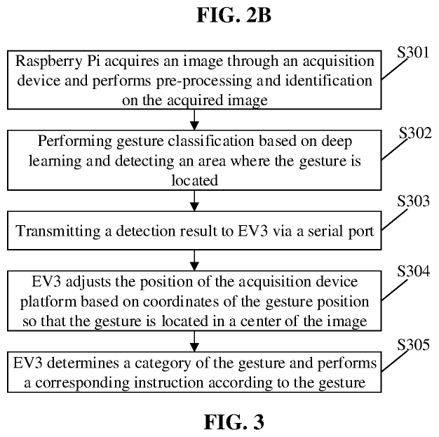

Based on this, an embodiment of the present disclosure provides a gesture recognition method. FIG. 3 is a schematic flowchart of a method for controlling intelligent device motion according to an embodiment of the present disclosure, and description will be made with reference to the method shown in FIG. 3.

In S301, Raspberry Pi acquires an image through an acquisition device, and performs pre-processing and identification on the acquired image.

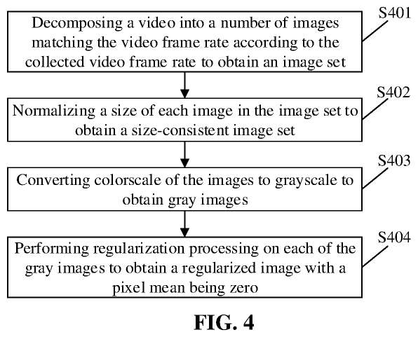

In some embodiments, a pre-processing procedure performed by the Raspberry Pi for the collected image includes the following operations. First, a size of the image to be processed is normalized to obtain a normalized image satisfying a predetermined size. Then, the normalized image is converted into a gray image. Finally, pixels of the gray image are restricted to obtain a regularized image with a pixel mean being zero. It should be understood that the Raspberry Pi may be a controller in an intelligent vehicle, which is configured to collect the image to be processed, and perform pre-processing and image identification of the image to be processed. That is, embodiments of the present disclosure may implement wireless remote control of the intelligent vehicle based on gesture recognition. The gesture recognition is performed by acquiring an image including a gesture, and then detecting and classifying the image by using a deep learning technology, which includes extracting a target area of the gesture and gesture classification. In order to acquire a better image, a platform for an acquisition device is set up, and the position of the acquisition device may be freely adjusted to obtain a better gesture image. Meanwhile, in order to improve the consistency of images sent to the network model, it is necessary to perform pre-processing on the acquired image first. The pre-processing procedure is shown in FIG. 4 and includes the following four steps.

In S401, a video is decomposed into a number of images matching the video frame rate according to the acquired video frame rate to obtain an image set.

For example, when the video decomposition is performed, it is necessary to consider the frame rate of the original video data, and the number of the decomposed images according to the frame rate of the video. For example, if the frame rate is 30, i.e., there are 30 images in one second of video, the one second of video is decomposed into 30 images.

In S402, a size of each image in the image set is normalized to obtain a image set with consistent size. In this way, the sizes of the images in the image set are normalized, which improves the consistency of the feature maps of the images in the input neural network.

In S403, color of each image is converted to gray to obtain gray images.

For example, the color characteristics of the each image are ignored so that the color image is converted to a gray image.

In S404, a regularization process is performed on each of the obtained gray images to obtain a regularized image with a pixel mean being zero. In this way, the regularization processing is performed on each gray image, so that the zero-mean characteristic of image is improved, and the weight convergence is accelerated.

In some embodiments, at the Raspberry Pi side, the gesture classification is achieved by a depth neural network model, of which the network input is the preprocessed image, and the output result includes two parts, i.e., a location of the gesture and a specific category of the gesture. In the embodiment of the present disclosure, gesture recognition integrates a gesture tracking function, and the overall process of the gesture classification is mainly divided into three stages: gesture detection, gesture tracking and gesture recognition.

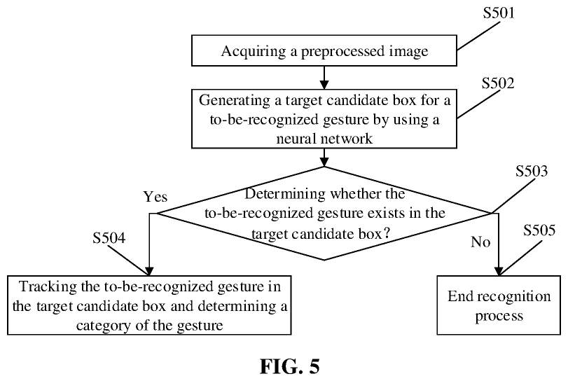

At the first stage, gesture detection is the first process of the gesture recognition system. After determining that there is a gesture target in an image, the image is tracked, recognized, and the like. In the related art, whether a gesture exists or not is determined based on color, contour, motion information, and the like in the image, while such manner is easily influenced by factors such as illumination, and thus results in large difference. Based on this, in the embodiment of the present disclosure, the image feature is automatically extracted through the neural network, and then gesture classification is completed. This process is as shown in FIG. 5 and includes the following steps.

In S501, a preprocessed image is acquired.

In S502, a target candidate box of a gesture is generated using a neural network.

In some embodiments, the neural network first extracts image features of the preprocessed image and builds a classifier network based on the image features, and then classifies each candidate box to determine whether there is a gesture in the candidate box.

In S503, it is determined whether there is a gesture in the target candidate box.

In some embodiments, if there is a gesture in the target candidate box, the process proceeds to S504. If there is no gesture in the target candidate box, the process proceeds to S505.

In S504, the gesture in the target candidate box is tracked and a category of the gesture is determined.

At the second stage, gesture tracking is the second process of the gesture recognition system. In some embodiments, in the video sequence of the video stream of the embodiment of the present disclosure, as the continuity of the gestures in the acquired image set, it is not necessary to process and analyze each frame image, but only to select part of image frames for the image analysis. Gestures are detected in the selected image and the position information of the gestures is determined, so that the trajectory of the gestures is extracted, which enhances the connection between successive image frames. Therefore, a compromise between accurate and real-time gesture tracking is realized, and robust tracking can be realized.

At the third stage, gesture recognition is the third process of the gesture recognition system. In this process, the gesture position, pose and gesture expression information are mainly described. In the embodiment of the present disclosure, the features extracted from the above process are detected and tracked, and the tracked trajectory information is processed. However, due to the varying complexity of the background, the position of the acquisition device platform is adjusted in real time to improve the effect of the gesture image.

In S302, gesture classification is performed based on deep learning, and an area where the gesture is located is detected.

In S303, a detection result is transmitted to the EV3 through a serial port.

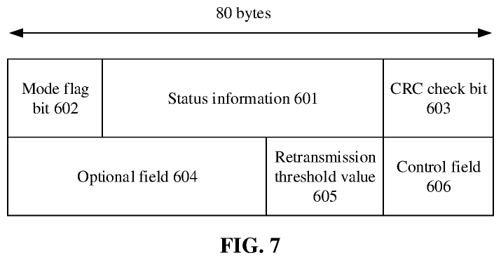

In some embodiments, after gestures are classified by depth neural network, the gesture category, coordinates of top left corner and lower right corner of the target candidate box are stored in a space of ten bytes. In the case where a plurality of target candidate boxes exists, the plurality of target candidate boxes are stored in sequence. In the case where there is no gesture in the image to be processed, the number 255 is used as a flag for identification. Then, the status information is encapsulated into a data field according to the customized communication protocol specification, and the data packet format is encapsulated as shown in FIG. 7. A mode flag bit 602 and a CRC check bit 603 are encapsulated on both sides of the status information 601 respectively, and then an optional field 604, a retransmission threshold 605 and a control field 606 as the message header are encapsulated. This protocol data packet is compatible with the TCP/IP (Transmission Control Protocol/Internet Protocol). After the encapsulation of the data is completed, data transmission is completed through the serial port, and parameters such as byte length, stop bit, and baud rate of the data packet need to be defined in the transmission.

In S304, the EV3 adjusts the position of the acquisition device platform based on position coordinates of the gesture, so that the gesture is located in a center of the image.

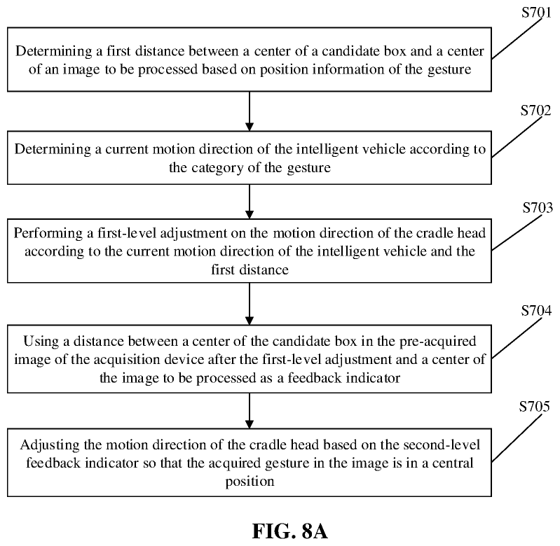

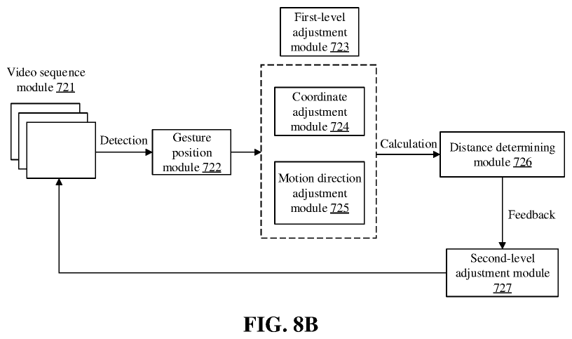

In some embodiments, the EV3 receives and parses the data packets from the Raspberry Pi side, and obtains category information of the gesture and position of the gesture from the fields of the data packet. Then, the EV3 integrates the motion state of the current intelligent vehicle and the gesture position information according to the position information of the gesture by means of adaptive feedback, so as to flexibly adjust the position of the platform to improve the effect of the acquired image. Adjustment of the platform is as shown in FIG. 8A and includes the following steps.

In S701, a first distance between a center of a candidate box and a center of an image to be processed is determined based on position information of the gesture.

In some embodiments, the first distance is used as a parameter criterion for adjusting the platform.

In S702, a current motion direction of the intelligent vehicle is determined according to the category of the gesture.

In S703, a first-level adjustment is performed on the motion direction of the platform is performed according to the current motion direction of the intelligent vehicle and the first distance.

In some embodiments, the current motion direction of the intelligent vehicle and the first distance are used as parameters for performing first-level adjustment on the motion direction of the platform. The motion direction adjustment and the gesture adjustment are integrated by using the fuzzy logic as an indicator for the first-level adjustment of the platform. For example, when the motion direction is advanced, the rise amount of the the platform is reduced in the vertical direction. When the moving direction is reverse, the rise amount of the platform is increased in the vertical direction.

A ratio of the size of the target candidate box to the size of the reference candidate box is determined, the motion direction and the first distance is updated based on the ratio, and the motion direction of the platform is adjusted based on the motion direction and the updated first distance.

The size of a reference target box for the gesture is set and the magnitude of weight is set according to the ratio of the target candidate box size to the reference target box, to adjust the motion direction and the first distance. The specific parameters are shown in Table 1.

In S704, a distance between a center of the candidate box in the pre-acquired image of the acquisition device subjected to the first-level adjustment and a center of the image to be processed is used as a feedback indicator.

In some embodiments, the first distance between the center of the candidate box and the center of the image to be processed may be reduced after the first-level adjustment of the platform, but there is still a difference between the center of the candidate box and the center of the image to be processed, and the difference is used as a second distance to perform the second feedback, so that the motion direction of the platform can be adjusted based on the difference to further adjust the acquisition direction of the acquisition device.

In S705, the motion direction of the platform is adjusted based on the second-level feedback indicator so that the gesture in an image acquired is in a central position of the image.

In the embodiment of the present disclosure, by repeating the above process, an adaptive adjustment of the platform can be realized.

The above S701 to S705 may be implemented by modules shown in FIG. 8B, including: a video sequence module 721, configured to acquire a video sequence; a gesture position module 722, configured to detect a gesture position in the video sequence and determine the gesture position, a first-level adjustment module 723, including a coordinate adjustment module 724 and a motion direction adjustment module 725, where the coordinate adjustment module 724 is configured to adjust the motion direction of the platform according to coordinates of the current position of the intelligent vehicle, and the motion direction adjustment module 725 is configured to adjust the motion direction of the platform according to the current motion direction of the intelligent vehicle; and a distance determining module 726, configured to determine a distance between the center of the candidate box in the pre-acquired image of the acquisition device subjected to the first-level adjustment and a center of the image to be processed.

Here, the distance determined by the distance determining module 726 is fed back to a controller as a feedback indicator to perform the second-level adjustment on the motion direction of the platform.

The module further includes a second-level adjustment module 727, configured to adjust the motion direction of the platform based on a second-level indicator so that the gesture in the acquired image is in a central position of the image.

For decomposing the video sequence, the position of the platform is adjusted by the following steps so that the acquisition device can acquire the gesture position all the time. Considering that the vehicle is in real-time motion, it is necessary to take the current motion direction as an adjustment parameter, specifically as follows. In the first step, by obtaining coordinates of the gesture position, a distance between the gesture position and the center of the image may be calculated, and the distance is used as a parameter criterion for adjustment of the platform. In the second step, the current motion direction of the vehicle is determined according to the gesture category. In the third step, motion direction adjustment and gesture adjustment are integrated by fuzzy logic as the indicator for first-level adjustment of the platform. When the motion direction is advanced, the rise amount of the platform is reduced in the vertical direction. When the moving direction is reverse, the rise amount of the platform is increased in the vertical direction. In the fourth step, the size of a target box is set for the reference gesture, the magnitude of weight is set according to the real size of the target box relative to the reference target box, and two adjustment parameters as shown in Table 1 are adjusted. In the fifth step, a second-level adjustment is performed according to the detection result for the target box of the gesture in the next-frame image after the first-level adjustment as the feedback indicator. By repeating the above process, an adaptive adjustment process of the platform can be realized.

TABLE 1
Parameter table for coordinate adjustment of coordinate and direction

| Ratio of target candidate box to | | Current motion |
|---|---|---|
| preset candidate box | First distance | direction |
| <0.8 | 1 | 0.5 |
| 0.8~1.2 | 1 | 0.6 |
| >1.2 | 1 | 0.8 |

In S305, EV3 determines a category of the gesture, and performs a corresponding instruction according to the gesture.

The EV3 may perform a corresponding motion according to the gesture category, where the motion includes 7 types of motion modes: forward, backward, right-angled left turn, right-angled right turn, arc-shaped left turn, arc-shaped right turn, and stop. The correspondences between the gesture categories and the motion modes are specifically shown in Table 2. A LEGO intelligent vehicle adopts a differential steering mechanism, which is realized by rotating a single tire when turning at a right angle, and is realized by controlling the left and right wheels to have different rotation speeds and rotation angles when turning at an arc shape, where the trajectory of the arc shape rotation is fixed because the turning angle and the speed of the vehicle are fixed.

TABLE 2
Correspondence table between gesture categories and motion modes

| Gesture category | Motion mode | Gesture category | Motion mode |
|---|---|---|---|
| Victory (FIG. 6b) | Forward | First (FIG. 6f) | Right-angled |
| | | | right turn |
| OK (FIG. 6a) | Backward | Grub (FIG. 6e) | Arc-shaped left |
| | | | turn |
| Palm (FIG. 6d) | Stop | Six (FIG. 6g) | Arc-shaped right |
| | | | turn |
| Thumb Up (FIG. 6c) | Right-angled | | |
| | left turn | | |

In the embodiment of the present disclosure, in order to improve the detection effect, a platform for the acquisition device is built and the rotation angle and area of the platform are set, so that the work stability of the platform is improved, and moreover, an adaptive algorithm for adjustment of the acquisition device is designed and is used by cooperating with the platform, so that the platform is adjusted in real time according to the gesture position, and thus the detection effect can be obviously improved. Moreover, the deep learning technology is applied to the field of wireless remote control and can be used in most remote control devices and embedded devices, which enables to have strong compatibility and low migration cost.

In other embodiments, the correspondence between gesture categories and motion modes in Table 2 may also be implemented as follows.

The motion mode “forward” corresponds to the gesture in FIG. 6h. The motion mode “stop” corresponds to the gesture in FIG. 6i. The motion mode “right-angled left turn” corresponds to the gesture in FIG. 6j. The motion mode “right-angled right turn” corresponds to the gesture in FIG. 6k. The motion mode “backward” corresponds to the gesture in FIG. 6l, and the like. In the embodiment of the present disclosure, the correspondence between the gesture categories and the motion modes may be a correspondence arbitrarily set between the gesture categories and the motion modes.

A wireless intelligent control scheme based on gesture recognition plays an important role in many fields, especially in an intelligent home system or a wireless remote control system, which can be compatible with all remote control interfaces and thus to replace a device-specific wireless remote controller. However, there are still many urgent problems to be solved in gesture recognition. First, the background of gestures is mostly cluttered and diverse, and how to effectively extract an area where the gesture is located in such background is a problem to be solved. Secondly, gestures of different regions, ages, and sexes may vary in shapes and angles, and how to build a robust model compatible with all systems is also a great challenge. These factors make gesture recognition more difficult. In addition, the result information of gesture recognition needs a well-established set of wireless communication protocol specifications to make the relevant instructions be executed accurately.

Embodiments of the present disclosure provide a complete set of scheme for intelligent vehicle wireless remote control based on gesture recognition, which includes: performing the gesture classification at the Raspberry Pi side, and controlling the intelligent vehicle to perform the corresponding instruction. On the Raspberry Pi side, the gesture region is segmented based on the depth neural network model to extract effectively gesture features, and gesture classification is completed. Based on the gesture position and pose analysis, an adaptive algorithm for adjusting the camera angle is designed to continuously correct the camera angle, so that the gesture is located in an image, and thus the accuracy of gesture recognition is improved. The scheme of the present disclosure is applicable to various complex environments.

According to the scheme provided by the embodiment of the disclosure, the wireless remote control of the intelligent vehicle based on gesture recognition can be realized, which mainly includes five steps as follows. First, the Raspberry Pi captures an image through the camera and performs relevant pre-processing. Second, the Raspberry Pi performs gesture classification based on the deep learning technology, and detects an area where the gesture is located. Third, the Raspberry Pi sends the detection result to the EV3 via a serial port. Fourth, the EV3 adjusts the position of the camera platform according to the position coordinates of the gesture so that the gesture is located in the center of the image. Fifth, the EV3 reads the category of the gesture and performs the corresponding instruction according to the gesture.

In order to improve the detection effect, a platform for the camera is set up in the scheme, and the rotation angle and area of the platform are set to improve the working stability of the platform.

According to the adaptive algorithm for adjusting the angle of the camera provided in the embodiment of the present disclosure, the algorithm is used by cooperating with the platform, and the platform is adjusted in real time according to the gesture position, so that the detection effect can be significantly improved.

In the embodiment of the present disclosure, the deep learning technology is applied to the field of wireless remote control and may be used in most remote control devices and embedded devices, which enables to have strong compatibility and low migration cost.

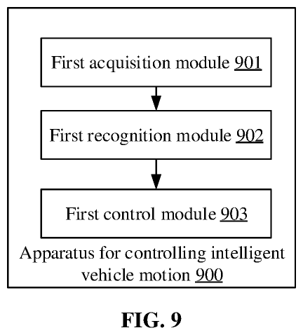

An embodiment of the present disclosure provides an apparatus for controlling intelligent device motion. FIG. 9 is a schematic structural diagram of an apparatus for controlling intelligent device motion according to an embodiment of the present disclosure. As shown in FIG. 9, the apparatus 900 includes a first acquisition module 901, a first recognition module 902 and a first control module 903.

The first acquiring module 901 is configured to acquire an image to be processed.

The first recognition module 902 is configured to perform gesture recognition on the image to be processed to obtain pose information of a gesture in the image to be processed.

The first control module 903 is configured to control a motion state of an intelligent vehicle according to the pose information.

In some embodiments, the apparatus further includes a first pre-processing module, configured to perform pre-processing on the image to be processed. The first pre-processing module includes a first processing sub-module, a first conversion submodule and a first regularization submodule. The first conversion submodule is configured to normalize a size of the image to be processed to obtain a normalized image satisfying a predetermined size. The first conversion submodule is configured to convert the normalized image into a gray image. The first regularization submodule is configured to perform regularization processing on pixels of the gray image to obtain a regularized image with a pixel mean being zero.

In some embodiments, the first recognition module 902 includes a first recognition submodule, configured to perform, based on a gesture recognition neural network, gesture recognition on the image to be processed to obtain the pose information of the gesture in the image to be processed.

In some embodiments, the first recognition submodule includes a first detection unit, a first classification unit, a first determining unit and a second determining unit. The first detection unit is configured to input the image to be processed to the gesture recognition neural network and detect a target candidate box. The first classification unit is configured to classify, through the gesture recognition network, the target candidate box to determine a gesture in the target candidate box, a direction of the gesture and a category of the gesture. The first determining unit is configured to determine position information of the gesture based on a position of the target candidate box. The second determining unit is configured to determine the pose information of the gesture in the image to be processed according to the position information of the gesture, the direction of the gesture and the category of the gesture.

In some embodiments, the position of the target candidate box is determined by: in a case where a center of the image to-be-processed is an origin, using coordinates of two diagonal corners of the target candidate box in the image to be processed as the position of the target candidate box

In some embodiments, the first control module 903 includes a first control submodule, configured to acquire an instruction corresponding to the gesture according to the received pose information and control the motion state of the intelligent vehicle according to the instruction.

In some embodiments, the apparatus further includes a first adjustment module, configured to adjust a camera connected to the intelligent vehicle according to the position of the target candidate box and the category of the gesture, so that the acquired image to be processed contains a gesture.

In some embodiments, the first adjustment module includes a first determining submodule and a first adjustment submodule. The first determining submodule is configured to determine a first distance between a center of the target candidate box and a center of the image to be processed according to the position of the target candidate box of the gesture. The first adjustment submodule is configured to adjust a distance between an image acquisition focus of the camera and the center of the image to be processed according to a negative correlation value of the first distance, to enable an image to be processed that is acquired by the camera subjected to adjustment contains the gesture.

In some embodiments, the first adjustment module includes a second determining submodule and a second adjustment submodule. The second determining submodule is configured to determine a current motion direction of the intelligent vehicle according to the category of the gesture and the direction of the gesture, where categories of the gesture and directions of the gesture have one-to-one correspondence with motion directions of the intelligent vehicle. The second adjustment submodule is configured to adjust an acquisition direction of the camera according to the current motion direction and a preset correspondence table, so that the image to be processed acquired by the camera subjected to adjustment contains the gesture. The preset correspondence table includes a correspondence between the current motion direction and the acquisition direction.

In some embodiments, the apparatus further includes a first determining module, a first updating module, a second adjustment module and a third adjustment module. The first determining module is configured to determine a ratio of a size of the target candidate box to a size of a preset candidate box. The first updating module is configured to update the first distance and the current motion direction respectively according to the ratio. The second adjustment module is configured to adjust a distance between a focus of the camera and a center of the image to be processed according to a negative correlation value of an updated first distance. A third adjustment module is configured to adjust the acquisition direction of the camera according to an updated current motion direction and the preset correspondence table, so that the image to be processed acquired by the camera subjected to adjustment contains the gesture.

In some embodiments, the first updating module includes a third determining submodule, a first updating submodule and a second updating submodule. The third determining submodule is configured to determine a first weight value corresponding to the first distance and a second weight value corresponding to the current motion direction according to the ratio. The first updating submodule is configured to update the first distance according to the first weight value to obtain the updated first distance. The second updating submodule is configured to update the current motion direction according to the second weight value to obtain the updated current motion direction.

In some embodiments, the apparatus further includes a second determining module, a third determining module and a fourth adjustment module. The second determining module is configured to determine a pre-acquired image from the camera after the acquisition direction of the camera is adjusted. The third determining module is configured to determine a second distance between a center of a target candidate box in the pre-acquired image and a center of the pre-acquired image, where the target candidate box contains a gesture. The fourth adjustment module is configured to adjust the acquisition direction of the camera according to the second distance, so that the target candidate box is located in a central area of the pre-acquired image, to enable the image to be processed that is acquired by the camera subjected to adjustment contains the gesture.

It should be noted that the above description of the apparatus embodiments is similar to that of the method embodiments, and has advantages similar to those of the method embodiments. For technical details not disclosed in the apparatus embodiments of the present disclosure, reference is made to the description of the method embodiments of the present disclosure. It should be noted that in the embodiments of the present disclosure, when the method for controlling intelligent device motion described above is implemented in the form of software function modules and sold or used as a separate product, the method for controlling intelligent device motion may also be stored in a computer readable storage medium. Based on such an understanding, the technical solution of the embodiments of the present disclosure, which essentially contributes to the prior art, may be embodied in the form of a software product stored in a storage medium including instructions for causing an instant messaging device (which may be a terminal, a server, or the like) to perform all or part of the methods described in the embodiments of the present disclosure. The storage medium includes a USB flash drive, a removable hard disk, a Read-Only Memory (ROM), a magnetic disk, or an optical disk, which can store program code. Thus, the embodiments of the present disclosure are not limited to any particular combination of hardware and software.

Correspondingly, the embodiments of the present disclosure further provide a computer program product including computer-executable instructions that, when being executed, enable the steps in the method for controlling intelligent device motion provided in the embodiments of the present disclosure. Correspondingly, an embodiment of the present disclosure further provides a computer storage medium having stored thereon computer-executable instructions that, when executed by a processor, implement the steps of the method for controlling intelligent device motion provided in the above embodiments.

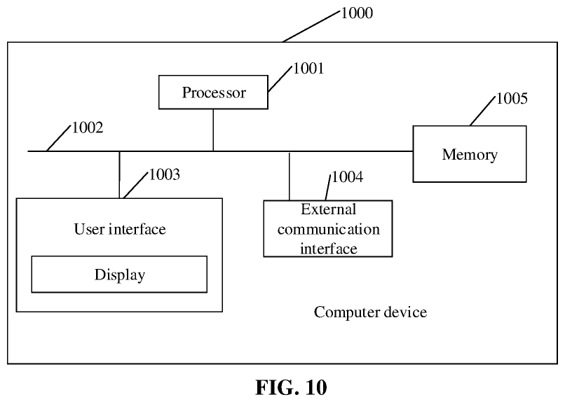

Correspondingly, an embodiment of the present disclosure provides a computer device. FIG. 10 is a schematic structural diagram of a computer device according to an embodiment of the present disclosure. As shown in FIG. 10, the device 1000 includes a processor 1001, at least one communication bus 1002, a user interface 1003, at least one external communication interface 1004, and a memory 1005. The communication bus 1002 is configured to implement connection communication among these components. The user interface 1003 may include a display screen, and the external communication interface 1004 may include a standard wired interface and/or wireless interface. The processor 1001 is configured to execute the image processing program stored in the memory to implement the steps of the method for controlling intelligent device motion provided in the above embodiments. The above description of the computer device and the storage medium embodiments is similar to the above description of the method embodiments, and has the advantages similar to the method embodiments. For technical details not disclosed in the computer device and storage medium embodiments of the present disclosure, reference is made to the description of the method embodiments of the present disclosure.

It is to be understood that reference throughout the specification to “one embodiment” or “an embodiment” means that a particular feature, structure, or characteristic associated with the embodiment is included in at least one embodiment of the present disclosure. Thus, the appearances of “in one embodiment” or “in an embodiment” may not necessarily refer to the same embodiment. Furthermore, these specific features, structures, or characteristics may be combined in any suitable manner in one or more embodiments. It is to be understood that, in the various embodiments of the present disclosure, the magnitude of the sequence numbers of the processes described above is not meant to mean the order of execution, and the order of execution of the processes should be determined by their function and intrinsic logic, and should not be construed as any limitation on the implementation of the embodiments of the present disclosure. The above-described embodiment numbers of the present disclosure are for description only and do not represent the advantages or disadvantages of the embodiments.

It is to be noted that, in this context, the terms “includes” “including” or any other variation thereof, are intended to cover a non-exclusive inclusion, such that a process, method, article, or apparatus that comprises a list of elements includes not only those elements but also other elements not expressly listed, or also includes elements inherent to such process, method, article, or apparatus. Without more limitations, an element defined by the statement “include a ” does not rule out those additional identical elements in a process, method, article, or apparatus that includes the element.

In the several embodiments provided herein, it is to be understood that the disclosed apparatus and method may be implemented in other ways. The device embodiments described above are merely illustrative, for example, the unit partitioning is only one logical function partitioning, and may be implemented in another partitioning manner, e.g., a plurality of units or components may be combined, or may be integrated into another system, or some features may be ignored, or not performed. In addition, the coupling, or direct coupling, or communication connection of the components shown or discussed with respect to each other may be through some interface, indirect coupling, or communication connection of a device or unit, which may be electrical, mechanical, or other form.

The units described above as separate parts may or may not be physically separate, and the components shown as units may or may not be physical units, the components may be located at one location or distributed across a plurality of network elements. Some or all of the units may be selected according to practical needs for the purposes of the embodiments of the present disclosure. In addition, each functional unit in each embodiment of the present disclosure may be integrated into a single processing unit, or each unit may be integrated into a single unit separately, or two or more units may be integrated into a single unit. The integrated unit may be implemented in the form of hardware or in the form of hardware plus software functional units.

It will be appreciated by those of ordinary skill in the art that all or a portion of the steps of the above-described method embodiments may be carried out by means of hardware associated with program instructions. The above-described program may be stored in a computer-readable storage medium. The program, when being executed, performs the steps of the above-described method embodiments. The storage medium includes various volatile or non-volatile media such as a removable storage device, a Read-Only Memory (ROM), a magnetic disk, or an optical disk that can store program code.

Alternatively, the integrated units described above may be stored in a computer-readable storage medium if implemented as a software functional module and sold or used as a separate product. Based on such an understanding, the technical solution of the embodiments of the present invention essentially contributes to the prior art, which may be embodied in the form of a software product stored in a storage medium including instructions for causing a computer device (which may be a personal computer, a server, or the like) to perform all or part of the methods described in the embodiments of the present invention. The foregoing storage medium includes various volatile or non-volatile media such as a removable storage device, a ROM, a magnetic disk, or an optical disk that can store program code.

The foregoing description is merely illustrative of the specific embodiments of the present disclosure, but the scope of protection of the present disclosure is not limited thereto. Variations or substitutions may readily occur to those skilled in the art within the technical scope disclosed in the present disclosure, and are intended to be included within the scope of protection of the present disclosure. Accordingly, the scope of protection of the present disclosure should be subject to the scope of protection of the claims.

1. A method for controlling intelligent vehicle motion, comprising:
acquiring an image to be processed;
performing gesture recognition on the image to be processed to obtain pose information of a gesture in the image to be processed; and
controlling a motion state of an intelligent vehicle according to the pose information.

2. The method of claim 1, wherein before performing gesture recognition on the image to be processed, the method further comprises:
performing pre-processing on the image to be processed,
wherein performing the pre-processing on the image to be processed comprises:
normalizing a size of the image to be processed to obtain a normalized image satisfying a predetermined size;
converting the normalized image into a gray image; and
performing regularization processing on pixels of the gray image to obtain a regularized image with a pixel mean being zero.

3. The method of claim 1, wherein performing gesture recognition on the image to be processed to obtain the pose information of the gesture in the image to be processed comprises:
performing, based on a gesture recognition neural network, gesture recognition on the image to be processed to obtain the pose information of the gesture in the image to be processed.

4. The method of claim 3, wherein performing, based on the gesture recognition neural network, gesture recognition on the image to be processed to obtain the pose information of the gesture in the image to be processed comprises:
inputting the image to be processed to the gesture recognition neural network and detecting a target candidate box;
classifying, through the gesture recognition neural network, the target candidate box to determine a gesture in the target candidate box, a direction of the gesture, and a category of the gesture;
determining position information of the gesture based on a position of the target candidate box; and
determining the pose information of the gesture in the image to be processed according to the position information of the gesture, the direction of the gesture and the category of the gesture.

5. The method of claim 4, wherein the position of the target candidate box is determined by:
in a case where a center of the image to be processed is an origin, using coordinates of two diagonal corners of the target candidate box in the image to be processed as the position of the target candidate box.

6. The method of claim 1, wherein controlling the motion state of the intelligent vehicle according to the pose information comprises:
acquiring an instruction corresponding to the gesture according to the pose information and controlling the motion state of the intelligent vehicle according to the instruction.

7. The method of claim 1, wherein before controlling the motion state of the intelligent vehicle according to the pose information, the method further comprises:
adjusting a camera connected to the intelligent vehicle according to a position of a target candidate box and a category of the gesture, so that the image to be processed contains the gesture.

8. The method of claim 7, wherein adjusting the camera connected to the intelligent vehicle according to the position of the target candidate box and the category of the gesture comprises:
determining a first distance between a center of the target candidate box and a center of the image to be processed according to the position of the target candidate box of the gesture; and
adjusting a distance between an image acquisition focus of the camera and the center of the image to be processed according to a negative correlation value of the first distance, to enable an image to be processed that is acquired by the camera subjected to adjustment contains the gesture.

9. The method of claim 7, wherein adjusting the camera connected to the intelligent vehicle according to the position of the target candidate box and the category of the gesture comprises:
determining a current motion direction of the intelligent vehicle according to the category of the gesture and a direction of the gesture, wherein categories of the gesture and directions of the gesture have one-to-one correspondence with motion directions of the intelligent vehicle; and
adjusting an acquisition direction of the camera according to the current motion direction and a preset correspondence table, to enable the image to be processed that is acquired by the camera subjected to adjustment contains the gesture, wherein the preset correspondence table comprises a correspondence between the current motion direction and the acquisition direction.

10. The method of claim 9, wherein after determining the current motion direction of the intelligent vehicle according to the category of the gesture and the direction of the gesture, the method further comprises:
determining a ratio of a size of the target candidate box to a size of a preset candidate box;
updating a first distance between a center of the target candidate box and a center of the image to be processed and the current motion direction respectively according to the ratio, wherein the first distance is determined according to the position of the target candidate box of the gesture;
adjusting a distance between a focus of the camera and a center of the image to be processed according to a negative correlation value of an updated first distance; and
adjusting the acquisition direction of the camera according to an updated current motion direction and the preset correspondence table, to enable the image to be processed that is acquired by the camera subjected to adjustment contains the gesture.

11. The method of claim 10, wherein updating the first distance and the current motion direction respectively according to the ratio comprises:
determining a first weight value corresponding to the first distance and a second weight value corresponding to the current motion direction respectively according to the ratio;
updating the first distance according to the first weight value to obtain the updated first distance; and
updating the current motion direction according to the second weight value to obtain the updated current motion direction.

12. The method of claim 10, wherein after adjusting the acquisition direction of the camera according to the updated current motion direction and the preset correspondence table, the method further comprises:
determining a pre-acquired image from the camera after the acquisition direction of the camera is adjusted;
determining a second distance between a center of a target candidate box in the pre-acquired image and a center of the pre-acquired image, wherein the target candidate box contains the gesture; and
adjusting the acquisition direction of the camera according to the second distance, so that the target candidate box is located in a central area of the pre-acquired image, to enable the image to be processed that is acquired by the camera subjected to adjustment contains the gesture.

13. An apparatus for controlling intelligent vehicle motion, comprising: a processor, and a memory configured to store instructions executable by the processor, wherein the processor is configured to:
acquire an image to be processed;
perform gesture recognition on the image to be processed to obtain pose information of a gesture in the image to be processed; and
control a motion state of an intelligent vehicle according to the pose information.

14. The apparatus of claim 13, wherein the processor is further configured to:
adjust a camera connected to the intelligent vehicle according to a position of a target candidate box and a category of the gesture, so that the image to be processed contains the gesture.

15. The apparatus of claim 14, wherein the processor is specifically configured to:
determine a first distance between a center of the target candidate box and a center of the image to be processed according to the position of the target candidate box of the gesture; and
adjust a distance between an image acquisition focus of the camera and the center of the image to be processed according to a negative correlation value of the first distance, to enable an image to be processed that is acquired by the camera subjected to adjustment contains the gesture.

16. The apparatus of claim 14, wherein the processor is specifically configured to:
determine a current motion direction of the intelligent vehicle according to the category of the gesture and a direction of the gesture, wherein categories of the gesture and directions of the gesture have one-to-one correspondence with motion directions of the intelligent vehicle; and
adjust an acquisition direction of the camera according to the current motion direction and a preset correspondence table, to enable an image to be processed that is acquired by the camera subjected to adjustment contains the gesture, wherein the preset correspondence table comprises a correspondence between the current motion direction and the acquisition direction.

17. The apparatus of claim 16, wherein the processor is further configured to:
determine a ratio of a size of the target candidate box to a size of a preset candidate box;
update a first distance between a center of the target candidate box and a center of the image to be processed and the current motion direction respectively according to the ratio, wherein the first distance is determined according to the position of the target candidate box of the gesture;
adjust a distance between a focus of the camera and a center of the image to be processed according to a negative correlation value of an updated first distance ; and
adjust the acquisition direction of the camera according to an updated current motion direction and the preset correspondence table, to enable an image to be processed that is acquired by the camera subjected to adjustment contains the gesture.

18. The apparatus of claim 17, wherein the processor is specifically configured to:
determine a first weight value corresponding to the first distance and a second weight value corresponding to the current motion direction respectively according to the ratio;
update the first distance according to the first weight value to obtain the updated first distance; and
update the current motion direction according to the second weight value to obtain the updated current motion direction.

19. The apparatus of claim 17, wherein the processor is further configured to:
determine a pre-acquired image from the camera after the acquisition direction of the camera is adjusted;
determine a second distance between a center of a target candidate box in the pre-acquired image and a center of the pre-acquired image, wherein the target candidate box contains the gesture; and
adjust the acquisition direction of the camera according to the second distance, so that the target candidate box is located in a central area of the pre-acquired image, to enable an image to be processed that is acquired by the camera subjected to adjustment contains the gesture.

20. A non-transitory computer storage medium, having stored thereon computer executable instructions that, when being executed, enable to implement the following operations:
acquiring an image to be processed;
performing gesture recognition on the image to be processed to obtain pose information of a gesture in the image to be processed; and
controlling a motion state of an intelligent vehicle according to the pose information.
